(19) United States
(12) Patent Application Publication
(10) Pub. No.: US 2007/0092191 A1
(43) Pub. Date: Apr. 26, 2007

(54) Optical fiber having reduced hydrogen induced loss and the method for producing the same

(76) Inventors: Ahmed Mohammed Koilakh, Maharashtra (IN); Jinesh Shah, Gujarat (IN); Deepak Thakur, Maharashtra (IN); Senthil Kumar Nageswaran, Maharashtra (IN)

Correspondence Address: James O. Ray, Jr.;Agent for Applicant(s), JAMES RAY & ASSOCIATES, 2640 Pitcairn Road, Monroeville, PA, 15146, US

(21) Appl. No.: 11/636,154

(22) Filed: Dec. 8, 2006

(30) Foreign Application Priority Data
Nov. 18, 2005 (IN) 1451/MUM/2005

(51) Int. Cl. G02B 6/02

(52) U.S. Cl. 385/123; 65/426

(57) ABSTRACT

A method for producing optical fiber having reduced hydrogen induced loss is provided wherein the optical fiber is treated with deuterium gas for a predetermined duration. The predetermined duration of deuterium treatment is determined based on three factors, that is, a) the concentration of deuterium at which fiber is to be treated with deuterium; b) the reaction temperature at which fiber is to be treated with deuterium; and c) the pressure inside the chamber at which fiber is to be treated with deuterium.

### FIELD OF THE INVENTION

The present invention relates to optical fiber having reduced hydrogen induced loss (hydrogen aging loss) and method for producing the same. Particularly, the present invention relates to a method for producing optical fiber having reduced hydrogen induced loss wherein the deuterium treatment duration is pre-determined based on three factors—a) the concentration of deuterium, b) the reaction temperature and c) the pressure inside the chamber where optical fiber is treated with deuterium gas.

### BACKGROUND OF THE INVENTION

Conventionally optical fiber is drawn from optical fiber preform produced by known methods like Modified Chemical Vapor Deposition (MCVD), Atmospheric Chemical Vapor Deposition (ACVD), Vapor Axial Deposition (VAD), Plasma Chemical Vapor Deposition (PCVD) etc.

The optical fiber preform produced from any of above known methods is required to be free from OH ions, that is does not produce OH absorption loss at 1383 nm. The concentration and species of the structural defects in the optical fiber are observed to be dependent upon drawing conditions and fabrication method of the preform.

In conventional methods, the optical fiber is drawn from the optical fiber preform, which is subjected to different temperatures in various process steps like in dehydration, consolidation and drawing process steps. In the dehydration process step, the optical fiber preform is formed in the atmosphere containing gases Helium, Oxygen and Chlorine gases. The gas concentration in dehydration and consolidation steps influences the transmission loss of optical fiber produced from the preform. For example, the oxygen rich atmosphere in the dehydration process step will increase the formation of oxygen-excessive defects (≡Si—O—O—Si≡) in the preform. In the drawing process step, the optical fiber preform is subjected to high temperature of about 2000 deg C. or more and the optical fiber is drawn with rapid cooling which in-turn result stress in the optical fiber, which is known to generate certain structural defects in optical fiber thus produced.

The primary object of telecommunication industry to transmit greater amounts of information, over longer distances, in shorter periods of time cannot be fulfilled with the optical fibers having said structural defects.

Conventionally, single mode optical fiber may be utilized for data transmission in the wavelength region ranging between about 1300 nm to about 1600 nm region. However, in these single mode fibers, the data transmission is carried out at about 1310 nm (O-band) and about 1550 nm (C-band) wavelength regions. The reason for not using the 1360-1460 nm (E-band) region for the data transmission in a standard single mode fiber is that high attenuation loss occurs at wavelength of 1383 nm of the signal during the transmission. The high attenuation loss of the transmitted signal is due to a high absorption band in said region at said wavelength of 1383 nm owing to the presence of moisture (OH ions) in the fiber. Therefore, the single mode fiber that can be used in the transmission of signal in the E-band region will be the one with no absorption band in said region at said wavelength of 1383 nm, that is with the optical fiber having no or reduced OH ions (low water peak) in the fiber. Due to high network capacity growth, the need for the utilization of the entire wavelength in the region from about 1200 nm to about 1625 nm, that is including O-band, C-band and E-band regions lead to the development of optical fibers having low water peak, that is having no or reduced OH ions.

In the optical fibers with low water peak (low OH ions), the transmission loss around the wavelengths of 1240 nm, 1383 nm, 1530 nm or the wavelength longer than 1530 nm etc. increases due to hydrogen diffusion from environment and this phenomenon of increase of transmission loss due to hydrogen diffusion from the environment over a period of time is termed as hydrogen aging loss of optical fiber. Accordingly, what is required is to not only to reduce the OH ions, but also not to form the OH ions by hydrogen reaction with structural defects, if any, which means ideally the optical fiber with no OH ions is need of the time.

It is observed that the above phenomenon of increase of transmission loss due to hydrogen diffusion from the environment over a period of time in the optical fiber is generated by the following mechanism.

The optical fiber produced have certain structural defects, which are generally generated during consolidation step and/or drawing step of manufacturing the optical fiber. These defects in the optical fiber are generally referred as non-bridging oxygen hole center (NBOHC) O≡Si—O^{•}, peroxy bridge (POR) O≡Si—O—O—Si≡O and tricoordinated silicon (usually named E′ center) O≡Si^{• [}New Hydrogen Aging Loss Mechanism in the 1400 nm Window” by K. H. Chang]. Among these structural defects, the non-bridge oxygen hole centre (NBOHC) and the peroxy bridge (POR) are known to increase the transmission loss after exposure to hydrogen environment.

The hydrogen molecules combine with the above defects to form atomic structures (like Si—OH and Si—H), which result in increase of transmission loss. Particularly the formation of Si—OH (refer to following equation 1) causes transmission loss at 1383 nm. Therefore, reducing hydrogen induced loss has become important for having long-term performance of the optical fiber.
2≡Si—O.+H₂→2≡Si—OH (1)

An attempt has been made to reduce the transmission loss due to formation of Si—OH on reacting with environmental hydrogen over a period of time, by treating the optical fibers with deuterium (heavy hydrogen) gas which results in formation of Si—OD by reacting with deuterium gas with structural defects as shown in following equation 2. It is the known fact that the Si—OD does not have any major absorption peak in the wavelength range from about 1200 nm to about 1625 nm. Therefore, the formation of Si—OD instead of Si—OH with structural defects appears to be better choice to have optical fiber having no or reduced hydrogen induced loss.

Accordingly, the present invention is directed to have such a method wherein the deuterium gas molecules react with structural defects thereby resulting in the formation of Si—OD which is known to have no absorption peak in the wavelength range from about 1200 nm to about 1625 nm, particularly no absorption peak at 1383 nm thereby reducing the transmission loss.

The exact mechanism of deuterium gas molecules reacting with structural defects to form Si—OD is not known, but it is believed that it may be as per following equation (2):
2≡Si—O.+D₂→2≡Si—OD (2)

Generally, the exchange of OH ions with OD ions, that is the isotope exchange between hydrogen and deuterium (heavy hydrogen) is performed either at high temperature (above 400° C.) or by irradiation [Isotope exchange reactions in vitreous silica—by B. Kumar Physics and chemistry of glasses Vol. 26 No. 6 (1985) PP 213-216)]. However, the optical fiber cannot withstand such a higher temperature and therefore, the commonly known isotope exchange method is not suitable for reducing hydrogen induced loss in the optical fibers.

The prior art [New Hydrogen Aging Loss Mechanism in the 1400 nm Window” by K. H. Chang] teaches a new hydrogen aging mechanism, according to which the structural defects in the optical fiber may react with hydrogen molecules to form new OH groups not present before. These new OH groups formed are irreversible even at the higher temperature and lead to increase in transmission loss at 1383 nm. Accordingly, further reaction with hydrogen does not occur while exposing to hydrogen environment. However, the main drawback of this method is that it does not teach how to reduce the hydrogen induced losses in an optical fiber.

The another prior art method [Japanese patent JP2003261351] teaching a method for reducing hydrogen induced losses in an optical fiber consists of exposing the optical fiber to the deuterium (heavy hydrogen) in a concentration lower than 4 volume % but higher than 1 volume % at an ambient atmosphere and at a temperature not exceeding 30° C. According to this method, such exposure is carried for at least for two days or more, preferably for four days or more.

The another disadvantage and limitation of above said method is that if the reaction temperature is higher than 30° C., then the transmission loss is not reduced to the expected level, that is it is higher than the expected level.

Still another disadvantage and limitation of above said method is that if the pressure of the chamber, that is the pressure at which the fiber is exposed to deuterium is higher than the ambient pressure then the basic requirement of satisfying the condition of Pa and day is not fulfilled even after three days of exposure. It may be noted that in term Pa and day, Pa indicates pressure of deuterium gas (measured in Pascal) and day indicates the number of days the optical fiber is treated with deuterium gas.

According to above said method, it is only when the optical fiber is exposed to deuterium at a deuterium concentration of lower than 4 volume % and higher than 1 volume % and at a temperature not exceeding 30° C. and the aging of transmission loss is controlled, that's too when the fiber is exposed to deuterium for at least two or more days, preferably for four or more days. Therefore, in accordance with the method taught in this prior art, one cannot think of carrying out deuterium treatment of a fiber at a deuterium concentration of more than 4 volume %, pressure of more than 1 volume % and temperature of more than 30° C.

Further, it has also been observed that according to above said method, the fiber is exposed to deuterium gas for an arbitrary duration and not for the predetermined duration. Therefore, this method leaves one to carry out the exposure by hit and trial means. Further, the inventors have observed that such arbitrary exposure of the fiber to deuterium gas results in fiber having unreated structural defects, if exposure is for shorter duration than what is required, and such unreacted structural defects, over a period of time, may react with hydrogen molecules from the environment and form new OH groups which were not present before. As stated herein above, these new OH groups formed are irreversible even at the higher temperature and lead to increase in transmission loss at 1383 nm meaning thereby the fiber treated with deuterium according to above prior art method will demonstrate hydrogen ageing loss. Further, it has also been observed that if deuterium treatment duration is for a longer duration than what is required, the fiber produced will have more deuterium gases in the fiber and the excess deuterium presence in the fiber increases attenuation loss at about 1550 nm, and hence, the deuterium gas is required to be removed from the fiber before it is subject to desired applications.

The another prior art [U.S. Pat. No. 4,685,945] also describes a method for deuterium treatment of optical fiber to reduce the peroxyl defects in drawn fiber. According to this prior art, the optical fiber bundles are exposed to the deuterium (D2) gas, either pure or diluted with an inert carrier gas such as nitrogen, argon and the like, at a pressure of from about 1 to about 10 atmospheres and at a temperature close to but no higher than that temperature at which the specific fiber can be treated without degradation or loss of other vital functions.

Even according to this prior art [U.S. Pat. No. 4,685,945] method, the fiber is exposed to deuterium gas for arbitrary duration and not for predetermined duration. As stated hereinabove, the inventors have observed that such arbitrary exposure of the fiber to deuterium gas results in fiber having unreated structural defects, if exposure is for shorter duration than what is required, and such unreacted structural defects, over a period of time, may react with hydrogen molecules from the environment and form new OH groups which were not present before. As stated herein above, these new OH groups formed are irreversible even at the higher temperature and lead to increase in transmission loss at 1383 nm meaning thereby the fiber treated with deuterium according to above prior art method will also demonstrate hydrogen ageing loss. Further, as stated herein above, it has also been observed that if deuterium treatment duration is for a longer duration than what is required, when the fiber is treated in accordance with this method, the fiber produced will also have more deuterium gases in the fiber and the excess deuterium presence in the fiber increases attenuation loss at about 1550 nm, and hence, the deuterium gas is required to be removed from the fiber before it is subject to desired applications.

Further, according to this prior art [U.S. Pat. No. 4,685,945] method, an additional process step of optically activating the peroxy linkages in the silica which reacted with D2 molecules by bathing the fibers with a light source of at least 10 Lambert Units and having a wavelength which is at least the short wavelength absorption edge of vitreous silica is required, which not only adds to process time, but also adds to cost, and hence makes this prior art [U.S. Pat. No. 4,685,945] method uneconomical. According to the method taught in this prior art, this light activation step is performed either simultaneously or subsequently to the D2 permeation step.

The another problem of this prior art [U.S. Pat. No. 4,685,945] method is not only increase of process time and process cost due to requirement of additional process step of optical activation of reacted peroxy linkages, but it has been observed that the optical activation of fiber treated with deuterium additionally requires a controlled step to passivating the defect sites, because if the defect sites are left activated, the very purpose of deuterium treatment will be forfeited. Due to requirement of controlled passivation step, this prior art method becomes further time consuming and expensive.

According to this prior art [U.S. Pat. No. 4,685,945] method duration of deuterium treatment is function of two features only that is pressure of deuterium and temperature at which the reaction is carried out.

However, it has been observed that this prior art [U.S. Pat. No. 4,685,945] method does not teach how to compute duration of deuterium treatment required to complete the reaction of D2 gases with defect sites so as to obtain the fiber having reduced hydrogen induced loss without performing the deuterium gas removal step.

From the forgoing description and prior art [New Hydrogen Aging Loss Mechanism in the 1400 nm Window” by K. H. Chang], it is understood that over a period of time, the unreacted structural defects even in the treated optical fiber react with hydrogen molecules from the environment to form new OH groups, which were not present before. Therefore, it is observed that if the structural defects in the optical fiber are not completely reacted with the deuterium gas during the deuterium treatment, the formation of Si—OH on exposure to the atmosphere containing hydrogen will result in increase in transmission loss.

### NEED OF THE INVENTION

Therefore, there is a need to have a method for producing optical fiber having reduced hydrogen induced loss and a fiber produced by such method wherein the deuterium treatment duration for treatment of the fiber with deuterium gas is pre-determined so that the method developed overcomes disadvantages and limitations of the prior art discussed hereinabove.

### OBJECTS OF THE INVENTION

The main object of the present invention is to provide a method for producing optical fiber having reduced hydrogen induced loss and a fiber produced by such method wherein the deuterium gas molecules react with structural defects in the optical fiber so as to form Si—OD which is known to have no absorption peak in the wavelength range from about 1200 nm to about 1625 nm, particularly no absorption peak at 1383 nm and said deuterium treatment of the fiber is carried out for a pre-determined duration meaning thereby the method developed overcomes disadvantages and limitations of the prior art discussed hereinabove.

The another object of the present invention is to provide a method for producing optical fiber having reduced hydrogen induced loss wherein the deuterium treatment duration for treatment of the fiber with deuterium gas is pre-determined while considering all three parameters of deuterium treatment, that is, a) concentration of deuterium, b) reaction temperature and c) pressure of the chamber wherein the optical fiber is treated with deuterium gas.

Still another object of the present invention is to provide an optical fiber having reduced hydrogen induced loss and exhibiting such attenuation loss at 1383 nm which is less than or equal to the maximum value specified for the range from 1310 nm to 1625 nm, even after hydrogen ageing according to IEC 60793-2-50.

Yet another object of the present invention is to provide a method for producing optical fiber having reduced hydrogen induced loss wherein possibly complete reaction of deuterium gas with structural defects in optical fiber is ensured to overcome the problem of formation of Si-OH on exposure to the atmosphere containing hydrogen meaning thereby the fiber produced will not demonstrate hydrogen ageing loss, but will demonstrate further decrease in transmission losses.

This is also an object of the present invention to provide a method for producing optical fiber having reduced hydrogen induced loss wherein not only peroxy bridge (POR) structural defects, but also non-bridge oxygen hole centre (NBOHC) structural defects in the fiber react with deuterium gas during predetermined duration, and hence, the present method results in a fiber which neither has peroxy bridge (POR) structural defects nor non-bridge oxygen hole centre (NBOHC) structural defects. .

This is also an object of the present invention to provide optical fiber which is suitable in the entire wavelength region varying from about 1200 nm to about 1625 nm, that is including O-band, C-band and E-band regions and still having low water peak, that is having no or reduced OH ions to satisfy the high network capacity.

Other objects, advantages and preferred embodiments of the present invention will become more apparent from the following description when read in conjunction with the accompanying drawings, which are not intended to restrict scope of the present invention, but are incorporated for illustration of preferred embodiments of the present invention.

### BRIEF DESCRIPTION OF THE INVENTION

The inventors have surprisingly observed that if deuterium treatment duration of the fiber is predetermined and the fiber is treated with deuterium gas for the predetermined duration, then disadvantages and limitations of the prior art discussed hereinabove are overcome.

The inventors have also observed that if deuterium treatment duration of the fiber is predetermined based on all three factors, that is,—a) concentration of deuterium, b) reaction temperature, and c) pressure of the chamber wherein the optical fiber is treated with deuterium gas, then it surprisingly results in formation of optical fiber having greatly reduced hydrogen induced loss, wherein all structural defects in the fiber react with the deuterium gas to form atomic structure Si—OD meaning thereby the treated fiber will not have unreated structural defects, and hence, the treated fiber, over a period of time, will not react with hydrogen molecules from the environment and form new OH groups which were not present before.

Therefore, it has been observed that reaction of fiber with deuterium gas for a predetermined duration computed based on above-said all three factors results in a fiber wherein new OH groups cannot be formed meaning thereby the fiber does not demonstrate increase in transmission loss over a period of time, that is does not demonstrate hydrogen ageing loss.

Accordingly, the present invention relates to a method for producing optical fiber having reduced hydrogen induced loss wherein said optical fiber is treated with deuterium gas for a predetermined duration.

In accordance with most preferred embodiment of the present invention, the predetermined duration for treatment of fiber with deuterium is determined based on all three factors, that is based on—a) the concentration of deuterium at which fiber is to be treated with deuterium, b) the reaction temperature at which fiber is to be treated with deuterium, and c) the pressure inside the chamber at which fiber is to be treated with deuterium.

In one embodiment, the present invention relates to optical fiber having reduced hydrogen induced loss which exhibits such attenuation loss at 1383 nm which is less than or equal to the maximum value specified for the range from 1310 nm to 1625 nm, even after hydrogen ageing according to IEC 60793-2-50.

Other preferred embodiments and advantages of the present invention will become apparent from following description when read in-conjunction with the accompanying figures which are not intended to limit scope of the present invention.

### BRIEF DESCRIPTION OF THE ACCOMPANYING DRAWING

FIG. 1 shows the optical fiber manufacturing process steps in accordance with one of the preferred embodiments of the present invention wherein the optical fiber treated with deuterium is subjected to hydrogen aging test.

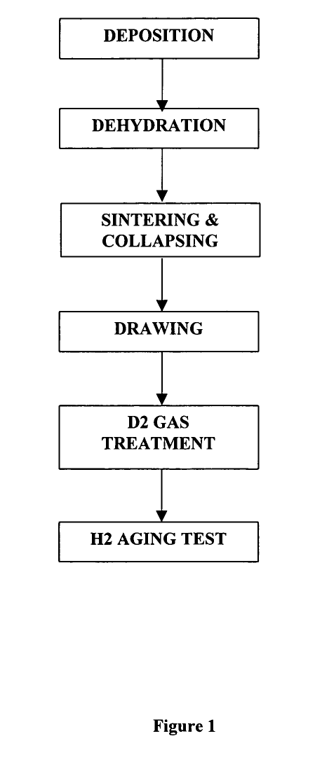

FIG. 2 shows the dehydration, and sintering and collapsing process steps to produce the optical fiber having reduced hydrogen induced loss from the optical fiber preform in accordance with one of the embodiments of the present invention.

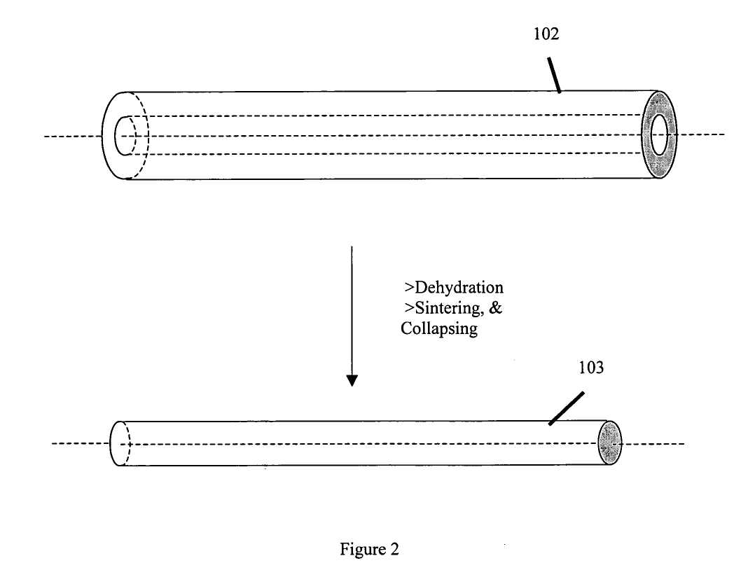

FIG. 3 shows spectral attenuation of the conventional single mode optical fiber and low water peak single mode optical fiber prepared in accordance with preferred embodiment of the present invention.

FIG. 4 shows various possible structural defects of the optical fiber which have been removed in the fiber produced in accordance with present method.

### DETAILED DESCRIPTION AND PREFERRED EMBODIMENTS OF THE INVENTION

Accordingly, the present invention relates to a method for producing optical fiber having reduced hydrogen induced loss characterized in that the optical fiber is treated with deuterium gas for a predetermined duration.

In accordance with most preferred embodiment of the present invention, the method for producing optical fiber having reduced hydrogen induced loss is characterized by treatment of fiber with deuterium for a predetermined duration which is determined based on following three factors:
a) the concentration of deuterium at which fiber is to be treated with deuterium;
b) the reaction temperature at which fiber is to be treated with deuterium; and
c) the pressure inside the chamber at which fiber is to be treated with deuterium.

In one embodiment, the present invention also relates to optical fiber having reduced hydrogen induced loss which exhibits attenuation loss at 1383 nm less than or equal to the maximum value specified for the range from 1310 nm to 1625 nm, even after hydrogen ageing according to IEC 60793-2-50, that is, having low water peak absorption at 1383 nm.

In accordance with present invention, the optical fiber is treated with deuterium gas for a predetermined duration, wherein said predetermined duration is determined, based on all three factors, that is based on—a) the concentration of deuterium at which fiber is to be treated with deuterium, b) the reaction temperature at which fiber is to be treated with deuterium, and c) the pressure inside the chamber at which fiber is to be treated with deuterium, by employing following regression relation shown in equation (3):
D=e+f×C+g×P+h×T (3)
Wherein,

D is Duration, in hours, for which the optical fiber should be treated with deuterium gas;

C is Concentration of deuterium gas, in volume percentage, at which fiber is to be treated with deuterium;

P is Pressure, in bar, at which fiber is to be treated with deuterium;

T is Temperature, in degree Celsius, at which fiber is to be treated with deuterium; and

e, f, g and h are constants of regression, and in accordance with present invention these constants are determined from the regression analysis.

In accordance with present invention, the said regression constants e, f, g and h vary within following respective ranges:
e=+152 to 158 (4)
f=−6.04 to −6.29 (5)
g=−8.48 to −8.82 (6)
h=−0.30 to −0.31 (7)

In accordance with present invention, using the regression constants varying within above-defined ranges defined in above equations (4), (5), (6) and (7) in above-defined regression relation shown in equation (3), the deuterium treatment duration is determined.

In accordance with present invention, by employing regression relationship defined in above equation (3), the duration required for treatment or reaction of the optical fiber with deuterium gas can be predetermined.

It may be noted that presently disclosed regression relationship defined in above equation (3) is based on all three factors, that is, based on—a) the concentration of deuterium at which fiber is to be treated with deuterium, b) the reaction temperature at which fiber is to be treated with deuterium, and c) the pressure inside the chamber at which fiber is to be treated with deuterium. Therefore, in accordance with present invention, for determining predetermined duration of treatment of fiber with deuterium a) the concentration of deuterium at which fiber is to be treated with deuterium, b) the reaction temperature at which fiber is to be treated with deuterium, and c) the pressure inside the chamber at which fiber is to be treated with deuterium should be known.

Therefore, in accordance with one embodiment, the present invention has been found to be suitable for a) any concentration of deuterium at which fiber is to be treated with deuterium, b) any reaction temperature at which fiber is to be treated with deuterium, and c) any pressure inside the chamber at which fiber is to be treated with deuterium.

In accordance with one of the preferred embodiments of the present invention, the present method has been found to be suitable for a concentration of deuterium varying from about 1% to about 10 vol. %.

In accordance with another preferred embodiment of the present invention, the present method has been found to be suitable for a temperature varying from about 20° C. to about 100° C. However, a care is taken that the coating of the fiber does not degrade at the selected temperature.

In accordance with still another preferred embodiment of the present invention, the present method has been found to be suitable for a pressure inside the chamber varying from about 1 bar to about 6 bar.

In accordance with most preferred embodiment of the present invention, the present method has been found to be suitable for a concentration of deuterium varying from about 1 vol. % to about 10 vol. %, a temperature varying from about 20° C. to about 100° C., and a pressure inside the chamber varying from about 1 bar to about 6 bar.

It has been surprisingly found that by employing presently disclosed regression relationship defined in equation (3), the deuterium treatment or reaction duration can be predetermined and minimized to such an extent that if the fiber is treated for the predetermined duration, then the method does not leave any unreacted structural defects, meaning thereby it surprisingly results in formation of optical fiber having greatly reduced hydrogen induced loss, wherein all structural defects in the fiber have reacted with the deuterium gas to form atomic structure Si—OD, and hence, the treated fiber will not have untreated structural defects, and therefore, the treated fiber, over a period of time, does not react with hydrogen molecules from the environment and form new OH groups which were not present before.

Therefore, the present method has been found to have advantage of resulting in a fiber wherein new OH groups cannot be formed meaning thereby the fiber does not demonstrate increase in transmission loss over a period of time, that is does not demonstrate hydrogen ageing loss.

It will be apparent from following examples, which are incorporated for describing the manner in which the present invention is to be performed and are not intended to limit its scope, that is, if a fiber is treated for the predetermined duration determined in accordance with the present invention, it does not show unreacted structural defects, meaning thereby the fiber demonstrates greatly reduced hydrogen induced loss, wherein all structural defects in the fiber have reacted with the deuterium gas to form atomic structure Si—OD.

It is also apparent from the following examples that the fiber treated with deuterium for a predetermined duration determined in accordance with present invention does not show formation of new OH groups meaning thereby the fiber treated in accordance with present invention does not demonstrate increase in transmission loss over a period of time, that is does not demonstrate hydrogen ageing loss.

It has also been observed that the fiber treated in accordance with present invention does not demonstrate increase in attenuation loss particularly at 1383 nm even after further treatment of the deuterium treated optical fiber with 1% by volume of hydrogen gas for 3 days at room temperature and atmospheric pressure (IEC 60793-2-50 method), which confirms that the fiber treated in accordance with present invention does not has any unreacted structural defects, that is, complete reaction of deuterium gas with structural defects in optical fiber is ensured by the present invention to overcome the problem of formation of Si—OH on exposure to the atmosphere containing hydrogen confirming that the fiber produced in accordance with present invention does not demonstrate hydrogen ageing loss and further increase in transmission losses.

From following example 2, it is also understood that by employing above-defined regression relationships defined in equation (3), it has become possible to minimize the duration of reacting or treating the optical fiber with deuterium to decrease the overall process time and enhance the productivity of the deuterium treatment process and thereby to reduce cost of the overall process, which makes it more economical.

It may be noted that the fiber employed in following examples, can be prepared by any known method. However, for example, it can be prepared by the method comprising:
a) producing soot porous body by depositing soot on the cylindrical member;
b) detaching the cylindrical member from soot porous body produced in above step-a) to form hollow cylindrical soot porous body;
c) dehydrating the hollow cylindrical soot porous body (102) produced in above step-b) in an atmosphere containing oxygen, helium and chlorine gases;
d) simultaneously sintering and collapsing said dehydrated hollow cylindrical soot porous body produced in above step-c) inside the sintering furnace to form optical fiber preform (103) suitable to produce optical fiber;
e) drawing the optical fiber from said optical fiber preform (103) produced in above step-d).

The prepared hollow cylindrical soot porous body (102) is transferred to the sintering furnace for dehydration, and simultaneously sintering and collapsing the said hollow cylindrical soot porous body (102) to form a solid glass preform (103) to convert the soot porous body (102) into solid glass preform (103) from which the fiber is drawn, which is subjected to deuterium treatment in accordance with present invention.

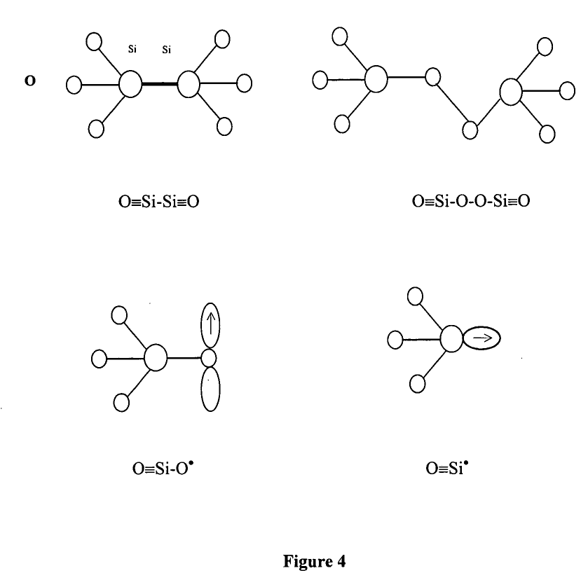

It has been found that the optical fiber produced in accordance with present invention, does not show any of the structural defects, including oxygen-excessive defects (≡Si—O—O—Si≡), non-bridge oxygen hole centre (NBOHC) and the peroxy bridge (POR) as shown in accompanying FIG. 4 meaning thereby does not show increase in transmission loss even after long exposure to hydrogen environment.

It may be noted that the present method has been found to be suitable for use on any fiber produced by any method and stored in any form including when fiber is stored on a spool.

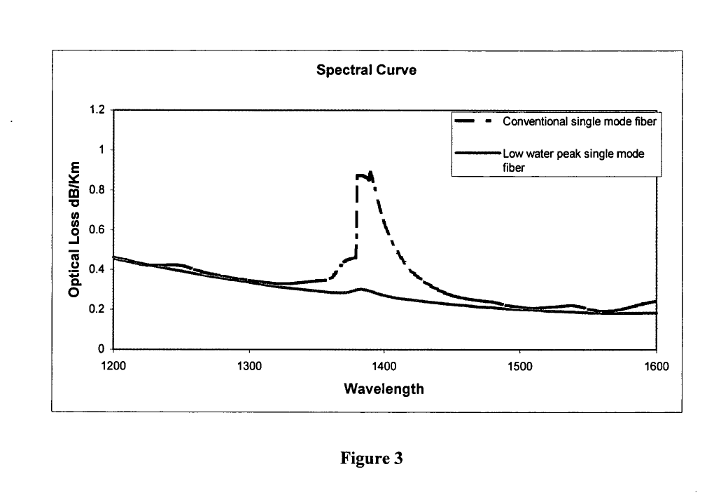

Before the start of treatment of optical fiber with deuterium gas, which may be taken as pure or as gas diluted with nitrogen gas, the optical fiber parameters are measured, for example, spectral attenuation at each wavelength. The attenuation at 1310, 1383 and 1550 nm are noted before starting the deuterium treatment process. The spectral attenuation of optical fiber produced in accordance with present invention and conventional method are as shown in FIG. 3 for the comparison purpose.

The optical fiber prepared in accordance with present method shows optical loss less than about 0.32 dB/km in the wavelength region of about 1360 to 1460 nm.

It may be noted that in accordance with present method, the treatment of fiber with deuterium can be carried out in any manner. For example, it can be carried out by wounding the optical fiber with plurality of bobbins placed inside the chamber wherein the deuterium gas is contacted therewith. The deuterium chambers are preferably heated with heaters provided around the chamber and the temperature inside the chamber is measured with the help of thermocouple or temperature transducer. The pressure monitor is preferably fitted on the chamber to measure the pressure inside the chamber. The pressure chamber is connected to deuterium gas supply and preferably also to the vacuum generator.

As exemplary embodiment, before placing the optical fiber bobbin inside the deuterium chamber, the chamber is evacuated by using vacuum generator to completely remove atmospheric air from the chamber. The chamber is well closed to withstand the pressure required for deuterium treatment.

It is understood from the forgoing description that by varying three parameters of deuterium treatment, that is,—i) the concentration of deuterium, ii) the reaction temperature and iii) the pressure inside the chamber where optical fiber is treated with deuterium gas one can reduce the treatment duration and can still have a fiber having desired characteristics as described hereinabove.

Accordingly, the optical fibers having no or reduced structural defects on account of complete reaction thereof with deuterium gas are produced by the present method and it has been observed that such optical fibers do not show increased transmission loss even after hydrogen aging in-addition to having reduced hydrogen induced loss and exhibiting attenuation loss at 1383 nm which is less than or equal to the maximum value specified for the range from about 1310 nm to about 1625 nm, after hydrogen ageing according to IEC 60793-2-50.

### EXAMPLES

### Example 1

A lot of optical fiber spools were to be passivated for hydrogen aging loss. The optical fiber spools were checked for transmission losses at the wavelengths of 1310 nm, 1383 nm and 1550 nm. The lot of optical fiber spools was placed inside the reacting chamber. The chamber after placing the optical fiber spools was sealed airtight. The chamber was then evacuated to remove the existing atmospheric gas inside the chamber. The chamber was then filled with a mixture of deuterium and nitrogen gas. The concentration of deuterium was 3% by volume and 97% nitrogen by volume. The pressure of the deuterium and nitrogen gas mixture was about 3 bar. The reacting temperature of the deuterium treatment process while contacting the deuterium and nitrogen gas mixture was about 23° C. The duration time for exposing the optical fiber spool lot was determined using the regression relation (3);
D=e+f×C+g×P+h×T (3)

Where the regression constants values are as follows
e=155.0
f=−6.04
g=−8.48
h=−0.30

By substituting the values for concentration of deuterium C, the pressure P, temperature T, and the above-mentioned values of e, f, g and h respectively we obtain the duration to be
D=103.94 hours

The optical fiber spool lot was exposed to the deuterium-nitrogen gas mixture for the duration of approximately 103.94 hours and at temperature of 23° C., pressure 3 bars and deuterium concentration of 3% by volume. One of the optical fiber spool was picked up randomly from the above lot of optical fiber spools and was subjected to hydrogen testing as per the IEC 60793-2-50, where the optical fiber spool is exposed to 1% hydrogen gas at room temperature and approximately 1 atmosphere pressure for 3 days. This particular spool, which was subjected to the hydrogen testing, was checked for transmission loss increase subsequent to the hydrogen testing, particularly at the 1383 nm wavelength. It was observed that there was no increase in the transmission loss particularly at the 1383 nm wavelength. The table 1 below gives the comparison of the transmission loss at the wavelength of interest 1383 nm for the optical fiber spool subjected to the hydrogen testing before deuterium treatment, after deuterium treatment and after hydrogen treatment.

TABLE 1

| | | Transmission loss |
|---|---|---|
| Sr. No. | Event | @ 1383 nm (dB/Km) |
| 1 | Before exposing to deuterium | 0.298 |
| | treatment | |
| 2 | After exposing to deuterium treatment | 0.298 |
| 3 | After hydrogen testing | 0.298 |

### Example 2

Another lot of optical fiber spools has been passivated for hydrogen aging loss. The optical fiber spools were checked for transmission losses at the wavelengths of 1310 nm, 1383 nm and 1550 nm. The duration for completing the deuterium treatment was to be shortened in comparison with the example 1. The lot of optical fiber spools was placed inside the reacting chamber. The chamber after placing the optical fiber spools was sealed airtight. The chamber was then evacuated to remove the existing atmospheric gas inside the chamber. The chamber was then filled with a mixture of deuterium and nitrogen gas. The concentration of deuterium was 6% by volume and 94% nitrogen by volume. The pressure of the deuterium and nitrogen gas mixture was selected about 6 bars. The reacting temperature of the deuterium treatment process while contacting the deuterium and nitrogen gas mixture was about 45° C. The duration time for exposing the optical fiber spool lot was determined using the regression relation (3);
D=e+f×C+g×P+h×T (3)

Where the regression constants values are as follows
e=155.0;
f=−6.04;
g=−8.48;
h=−0.30

By substituting the values for concentration of deuterium C, the pressure P, temperature T and the values of regression constants mentioned above we obtain the duration to be
D=54.38 hours

The optical fiber spool lot was exposed to the deuterium-nitrogen gas mixture for the duration of approximately 54.38 hours and at temperature of 45° C., pressure 6 bar and deuterium concentration of 6% by volume. One of the optical fiber spool was picked up randomly from the above lot of optical fiber spools and was subjected to hydrogen testing as per the IEC 60793-2-50, where the optical fiber spool is exposed to 1% hydrogen gas at room temperature and approximately 1 atmosphere pressure for 3 days. This particular spool, which was subjected to the hydrogen testing, was checked for transmission loss increase subsequent to the hydrogen testing, particularly at the 1383 nm wavelength. It was observed that there was no increase in the transmission loss particularly at the 1383 nm wavelength. The table 1 below gives the comparison of the transmission loss at the wavelength of interest 1383 nm for the optical fiber spool subjected to the hydrogen testing before deuterium treatment, after deuterium treatment and after hydrogen treatment.

TABLE 2

| | | Transmission loss |
|---|---|---|
| Sr. No. | Event | @ 1383 nm (dB/Km) |
| 1 | Before exposing to deuterium | 0.307 |
| | treatment | |
| 2 | After exposing to deuterium treatment | 0.308 |
| 3 | After hydrogen testing | 0.307 |

From the forgoing examples, it is clear that present method produces an optical fiber in a shortest possible duration and still having reduced hydrogen induced loss wherein the deuterium gas molecules have completely reacted with structural defects, including peroxy bridge (POR) and non-bridge oxygen hole centre (NBOHC) structural defects in the optical fiber and formed Si—OD, and left no unreacted structural defects which is confirmed by no absorption peak at 1383 nm in case of fiber produced by present method, and the fiber produced has not demonstrated hydrogen ageing loss and further increase in transmission losses, and has been found to be suitable in the entire wavelength region varying from about 1200 nm to about 1625 nm, including O-band, C-band and E-band regions and still having low water peak, that is, having no or reduced OH ions to satisfy the high network capacity.

It is apparent from the foregoing description that the presently disclosed method has overcome disadvantages, limitations and drawbacks of the prior art.

It may be noted that various terms as employed herein are merely intended to illustrate the present invention and are not intended to restrict scope of the present invention. It is obvious for the persons skilled in the art that alternative terms may also be employed to describe the present method without deviating from the intended scope of the present invention.

It may also be noted that the presently disclosed method has been described with reference to ACVD method. However, as stated herein above, the present method is suitable even for other alternative methods known for producing fiber.

1. A method for producing optical fiber having reduced hydrogen induced loss characterized in that the optical fiber is treated with deuterium gas for a predetermined duration.

2. A method as claimed in claim 1, characterized in that said predetermined duration is determined based on following three factors:
a) the concentration of deuterium at which fiber is to be treated with deuterium;
b) the reaction temperature at which fiber is to be treated with deuterium; and
c) the pressure inside the chamber at which fiber is to be treated with deuterium.

3. A method as claimed in claim 1, characterized in that said predetermined duration is determined by employing following regression relation shown in equation (3):
D=e+f×C+g×P+h×T (3)
wherein, D is duration of treatment, in hours, for which the optical fiber should be treated with deuterium gas;
C is concentration of deuterium gas, in volume percentage, at which fiber is to be treated with deuterium;
P is pressure, in bar, at which fiber is to be treated with deuterium;
T is temperature, in degree Celsius, at which fiber is to be treated with deuterium; and
e, f, g and h are constants of regression.

4. A method as claimed in claim 3, wherein said regression constant e varies within following respective range:
e=152 to 158. (4)

5. A method as claimed in claim 3, wherein said regression constant f varies within following respective range:
f=−6.04 to −6.29. (5)

6. A method as claimed in claim 3, wherein said regression constant g varies within following respective range:
g=−8.48 to −8.82. (6)

7. A method as claimed in claim 3, wherein said regression constant h varies within following respective range:
h=−0.30 to −0.31. (7)

8. A method as claimed in claim 3, wherein said equation (3) is suitable for
a) any concentration of deuterium at which fiber is to be treated with deuterium,
b) any reaction temperature at which fiber is to be treated with deuterium, and
c) any pressure inside the chamber at which fiber is to be treated with deuterium.

9. A method as claimed in claim 2, wherein said concentration of deuterium varies from about 1 vol. % to about 10 vol. % of inert gas.

10. A method as claimed in claim 2, wherein said temperature varies from about 20° C. to about 100° C.

11. A method as claimed in claim 2, wherein said pressure inside the chamber varies from about 1 bar to about 6 bar.

12. A method as claimed in claim 2, wherein said concentration of deuterium varying from about 1 vol. % to about 10 vol. % of inert gas, temperature varies from about 20° C. to about 100° C., and a pressure inside the chamber varies from about 1 bar to about 6 bar.

13. An optical fiber characterized by having reduced hydrogen induced loss.

14. An optical fiber as claimed in claim 13, wherein the optical fiber is characterized by having no or reduced structural defects, including oxygen-excessive defects (≡Si—O—O—Si≡), non-bridge oxygen hole centre (NBOHC) and the peroxy bridge (POR).

15. An optical fiber as claimed in claim 13, wherein optical fiber shows optical loss less than about 0.32 dB/km in the wavelength region of about 1360 to 1460 nm.

16. An optical fiber as claimed in claims 13, wherein optical fiber does not show increased transmission loss even after hydrogen aging.

17. An optical fiber as claimed in claims 13, wherein optical fiber exhibits attenuation loss at 1383 nm which is less than or equal to the maximum value specified for the range from about 1310 nm to about 1625 nm, after hydrogen ageing according to IEC 60793-2-50.

18. A method for producing optical fiber having reduced hydrogen induced loss comprising the steps of:
i) contacting the deuterium gas either pure or mixture of deuterium gas and inert gas with the optical fiber contained inside the chamber;
ii) keeping the pressure inside the chamber below 6 bar; and
iii) reacting the deuterium with structural defects at the reaction temperature which is not above a temperature at which the coated optical fiber degrads;
characterized in that
the deuterium treatment duration is predetermined and said predetermined duration is determined based on following three factors:
a) the concentration of deuterium at which fiber is to be treated with deuterium;
b) the reaction temperature at which fiber is to be treated with deuterium; and
c) the pressure inside the chamber at which fiber is to be treated with deuterium.
